(19) United States
(12) Patent Application Publication
(10) Pub. No.: US 2025/0063235 A1
(43) Pub. Date: Feb. 20, 2025

(54) SERVER AND METHOD FOR PROVIDING THREE-DIMENSIONAL VIDEO CONTENT AND DEVICE FOR PLAYING VIDEO CONTENT

(71) Applicant: Electronics and Telecommunications Research Institute, Daejeon (KR)

(72) Inventors: Bok Deuk SONG, Daejeon (KR); Sung Hoon KIM, Daejeon (KR); Hong Kyw CHOI, Daejeon (KR)

(21) Appl. No.: 18/803,406

(22) Filed: Aug. 13, 2024

(30) Foreign Application Priority Data
Aug. 16, 2023 (KR) 10-2023-0107228

(51) Int. Cl. H04N 21/81

(52) U.S. Cl. CPC H04N 21/816

(57) ABSTRACT

Provided are a server and method for providing three-dimensional (3D) video content and a device for playing video content. A 3D video content service server includes a server communication module, a server memory, and a server processor. When user interaction editing information for 3D video content is input, the server processor edits a user interaction for the 3D video content according to the user interaction editing information and generates and stores metadata for the edited user interaction.

### CROSS-REFERENCE TO RELATED APPLICATION

This application claims priority to and the benefit of Korean Patent Application No. 10-2023-0107228, filed on Aug. 16, 2023, the disclosure of which is incorporated herein by reference in its entirety.

### BACKGROUND

### 1. Field of the Invention

The present invention relates to a server for providing three-dimensional (3D) video content according to a user interaction on various platforms which are provided in web service environments and a device and method for playing video content.

### 2. Discussion of Related Art

Three-dimensional (3D) video services according to the related art are programmed with a single scenario for a supported environment according to a type of 3D video, and are provided using proper user interactions for the single scenario.

A problem with these 3D video services is that it is necessary to develop 3D video play and control software for each platform depending on a supported device and software environment.

In addition, to view a 3D video according to various scenarios, it is necessary to develop software in which user interactions are programmed.

The background art of the present invention is disclosed in Korean Patent Publication No. 10-2007432 (Aug. 6, 2019).

### SUMMARY OF THE INVENTION

The present invention is directed to providing a server for providing a three-dimensional (3D) video content service according to a user interaction which allows a user to edit and generate user interactions according to various scenarios and play a 3D video according to a user interaction on various platforms which are provided in web service environments, and a device and method for playing video content.

According to an aspect of the present invention, there is provided a server for providing a 3D video content service, the server including a server communication module, a server memory, and a server processor connected to the server communication module and the server memory. When user interaction editing information for 3D video content is input, the server processor edits a user interaction for the 3D video content according to the user interaction editing information and generates and stores metadata for the edited user interaction.

When a video content play device requests the server processor to play the 3D video content through the server communication module, the server processor may transmit 3D video content information including at least one of the 3D video content, metadata for the 3D video content, the metadata for the user interaction, and 3D video content player information to the video content play device such that the 3D video content is played by the video content play device.

The server processor may transmit a user interaction guide message for requesting a corresponding user interaction at a user interaction occurrence time which is set according to a scenario of the played 3D video content to the video content play device through the server communication module.

When a user interaction recognition success message is received from the video content play device, the server processor may play 3D video content corresponding to the user interaction.

The server processor may recognize a video player which will play a plurality of types of 3D video content and user interaction information using an interactive 3D video content player application programming interface (API) and an interaction API.

According to another aspect of the present invention, there is provided a device for playing video content, the device including a communication module, a memory, a motion recognition module, and a processor connected to the communication module, the memory, and the motion recognition module. The processor receives 3D video content from a 3D video content service server through the communication module and plays the 3D video content according to a 3D video content play request. When a user interaction is recognized by the motion recognition module while the 3D video content is played, the processor determines whether the recognized user interaction is appropriate, and when the recognized user interaction is appropriate, the processor plays 3D video content corresponding to the recognized user interaction.

In response to the 3D video content play request, the processor may receive 3D video content information including at least one of the 3D video content, metadata for a user interaction, metadata for the 3D video content, and 3D video content player information for playing the 3D video content from the 3D video content service server.

The processor may play the 3D video content using a 3D video content player corresponding to the 3D video content player information.

When a user interaction guide message is received from the 3D video content service server while the 3D video content is played, the processor may output interaction guide information for describing user interactions applied to the video content play device.

The processor may determine whether the recognized user interaction is appropriate for user interaction metadata which is set for a corresponding point in time, and when the recognized user interaction is appropriate, transmit a user interaction recognition success message to the 3D video content service server, receive 3D video content corresponding to the user interaction from the 3D video content service server, and play the received 3D video content.

The motion recognition module may include at least one of a leap motion device, a webcam, and a touchscreen.

According to another aspect of the present invention, there is provided a method of providing a 3D video content service according to a user interaction, the method including: providing, by a 3D video content service server, a web-based interactive 3D video content play environment on a video content play device; transmitting, by the 3D video content service server, 3D video content information of 3D video content requested by the video content play device to the video content play device; playing, by the video content play device, the 3D video content; when the played 3D video content requires a user interaction, transmitting, by the 3D video content service server, a user interaction guide message to the video content play device; and when a user interaction is recognized, playing, by the video content play device, 3D video content corresponding to the recognized user interaction.

The playing of the 3D video content may include playing, by the video content play device, the 3D video content using a 3D video content player corresponding to 3D video content player information included in the 3D video content information.

The playing of the 3D video content corresponding to the recognized user interaction may include: outputting, by the video content play device, interaction guide information for describing user interactions applied to the video content play device; when the user interaction is recognized, determining, by the video content play device, whether the recognized user interaction is appropriate; and when the user interaction is appropriate, playing, by the video content play device, 3D video content corresponding to the recognized user interaction.

The outputting of the interaction guide information may include recognizing, by the video content play device, the type of video content play device using a device interaction API and outputting interaction guide information for describing user interactions applied to the recognized type of video content play device.

The determining of whether the recognized user interaction is appropriate may include determining, by the video content play device, whether the recognized user interaction is appropriate for user interaction metadata which is set for a corresponding point in time.

The playing, by the video content play device, of the 3D video content corresponding to the recognized user interaction when the user interaction is appropriate may include: transmitting, by the video content play device, a user interaction recognition success message to the 3D video content service server; analyzing, by the 3D video content service server, user interaction metadata included in the user interaction recognition success message to recognize the user interaction and providing 3D video content corresponding to the recognized user interaction on the video content play device; and receiving and playing, by the video content play device, the 3D video content corresponding to the user interaction.

The method may further include: receiving, by the 3D video content service server, user interaction editing information for the 3D video content to edit the user interaction for the 3D video content; and generating, by the 3D video content service server, metadata for the edited user interaction.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a system for providing three-dimensional (3D) video content in accordance with a user interaction according to an exemplary embodiment of the present invention;

FIG. 2 is a schematic block diagram of a 3D video content service server according to an exemplary embodiment of the present invention;

FIG. 3 is a diagram illustrating functions of a server processor shown in FIG. 2;

FIG. 4 is a schematic block diagram of a video content play device according to an exemplary embodiment of the present invention;

FIG. 5 is a diagram illustrating functions of a processor shown in FIG. 4;

FIG. 6 is a flowchart illustrating a method of editing a user interaction for 3D video content according to an exemplary embodiment of the present invention; and

FIG. 7 is a flowchart illustrating a method of providing 3D video content according to an exemplary embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts arc denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

A server for providing three-dimensional (3D) video content in accordance with a user interaction and a device and method for playing video content according to exemplary embodiments of the present invention will be described below. In this process, the thicknesses of lines, the sizes of components, and the like shown in the drawings may be exaggerated for the purpose of clarity and convenience of description. Also, terms to be described below are defined in consideration of functions in the present invention, and the terms may vary depending on the intention of a user or operator or precedents. Therefore, these terms are to be defined on the basis of the overall content of the specification.

To view various 3D videos according to environments in which 3D videos are provided, technology is necessary that allows a user to edit and generate user interactions according to various scenarios and enables 3D videos to be provided regardless of a service platform.

Therefore, the present invention relates to a technology for selecting, editing, and generating various user interactions according to a scenario conceived by a creator to increase a viewer's interest and immersion when the viewer views a 3D video, and allowing the viewer to view the 3D video according to a user interaction on a platform provided in a web service environment. In other words, the present invention allows a user to view 3D videos according to various user interactions, such as user motions, push and pop messages, and the like, on various platforms which are provided in web service environments without being limited to a specific operating system (OS).

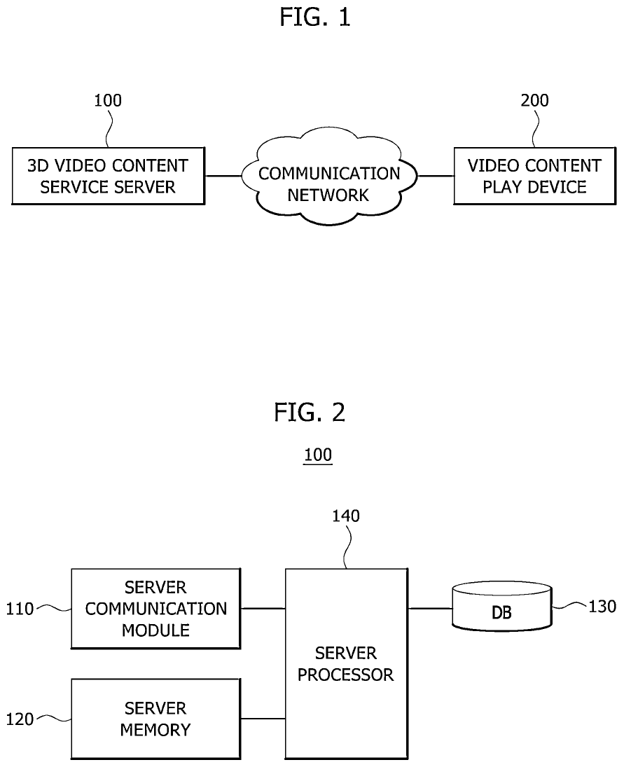

FIG. 1 is a block diagram of a system for providing 3D video content according to a user interaction according to an exemplary embodiment of the present invention.

Referring to FIG. 1, the system providing 3D video content according to a user interaction according to the exemplary embodiment of the present invention includes a 3D video content service server 100 and a video content play device 200.

When user interaction editing information for 3D video content is input, the 3D video content service server 100 may edit a user interaction for the 3D video content according to the user interaction editing information and generate and store metadata for the edited user interaction.

Also, when the video content play device 200 requests play of 3D video content, the 3D video content service server 100 may transmit 3D video content information including the 3D video content, metadata for the 3D video content, metadata for user interactions, 3D video content player information, and the like to the video content play device 200 such that the 3D video content is played by the video content play device 200.

The 3D video content service server 100 will be described below in detail with reference to FIG. 2.

In response to the 3D video content play request, the video content play device 200 may receive the 3D video content from the 3D video content service server 100 and play the 3D video content. Here, the 3D video content may include 3D video content that is provided according to a user interaction.

Also, when a user interaction is recognized while the 3D video content is played, the video content play device 200 may determine whether the recognized user interaction is appropriate, and when the recognized user interaction is appropriate, play 3D video content corresponding to the recognized user interaction.

The video content play device 200 may play the 3D video content using an interactive 3D video content player.

The video content play device 200 may include a motion recognition module 230 for recognizing motions of a user. The motion recognition module 230 may include a leap motion device, a webcam, a touchscreen, and the like.

The video content play device 200 may include a smart pad, a smartphone, a smart television, a kiosk, digital signage, and the like.

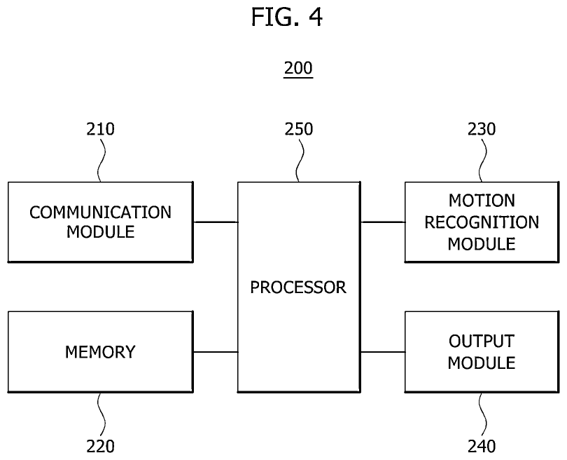

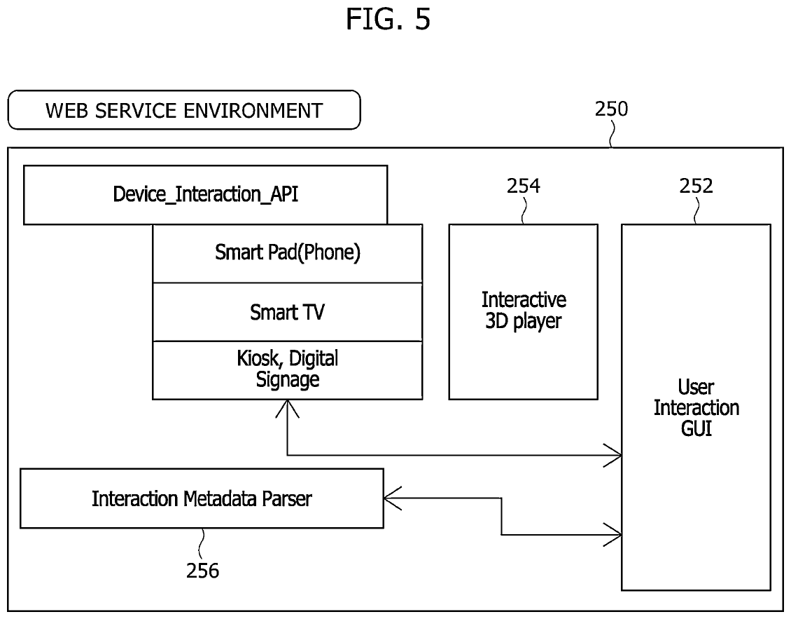

The video content play device 200 will be described in detail below with reference to FIG. 4.

The system for providing 3D video content which is configured as described above may provide a web-based interactive 3D video content play environment. Therefore, the system allows a user to view 3D videos according to various user interactions, such as user motions, push-and-pop messages, and the like, on various platforms which are provided in web service environments without being limited to a specific OS.

Also, the system for providing 3D video content according to the present invention edits and generates user interactions according to various scenarios and plays 3D videos according to the user interactions on various platforms which are provided in web service environments. Accordingly, it is unnecessary to install additional software for playing interactive 3D video content, and a user's interest and immersion can be increased when the user views 3D video content.

The system for providing 3D video content can be used in education, tour service, and the like in which interactive 3D video content is providable.

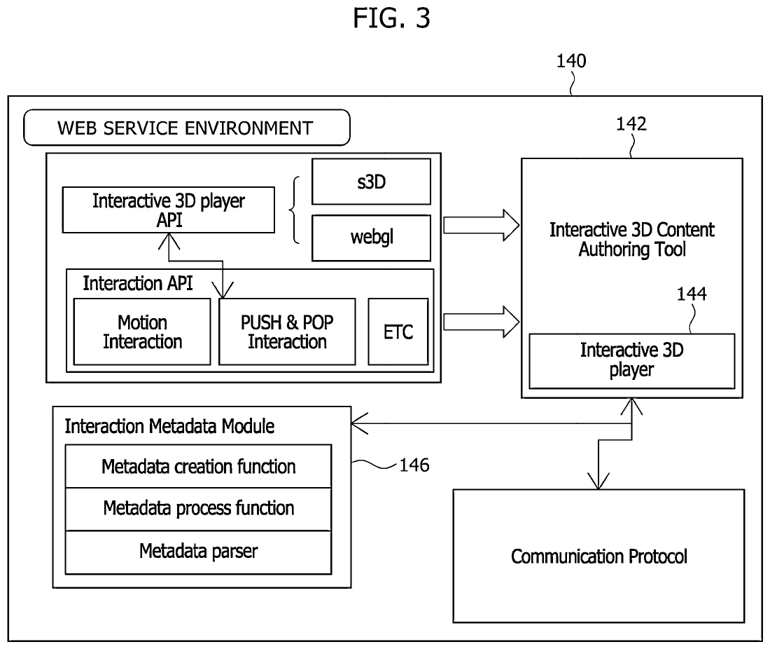

FIG. 2 is a schematic block diagram of a 3D video content service server according to an exemplary embodiment of the present invention, and FIG. 3 is a diagram illustrating functions of a server processor shown in FIG. 2.

Referring to FIG. 2, the 3D video content service server 100 according to the exemplary embodiment of the present invention includes a server communication module 110, a server memory 120, a database (DB) 130, and a server processor 140.

The server communication module 110 may provide an interface that is required for providing signals, which are transmitted and received between the 3D video content service server 100 and the video content play device 200, in the form of packet data through a communication network. In particular, the server communication module 110 may transmit and receive various types of information such as 3D video content, metadata, and the like. Also, the server communication module 110 may be a device including hardware and software required for transmitting and receiving signals, such as a control signal and a data signal, to and from another network device through wired or wireless communication. In addition, the server communication module 110 may be implemented in various forms such as a short-range communication module, a wireless communication module, a mobile communication module, a wired communication module, and the like.

The server memory 120 is a component in which data related to operations of the 3D video content service server 100 is stored. In particular, the server memory 120 may store an application (program or applet) for editing user interactions for 3D video content and playing 3D video content of which playing is requested, and information to be stored may be selected by the server processor 140 as necessary. In other words, the server memory 120 may store various types of data that are generated in the process of executing an OS or application (program or applet) for operating the 3D video content service server 100. Here, the server memory 120 collectively refers to non-volatile storage devices that continuously maintain stored information without power and volatile storage devices that require power to maintain stored information.

The DB 130 may store 3D video content, metadata for 3D video content, metadata for user interactions for 3D video content, and the like.

The server processor 140 may be implemented as at least one of an application-specific integrated circuit (ASIC), a digital signal processor (DSP), a programmable logic device (PLD), a field-programmable gate array (FPGA), a central processing unit (CPU), a microcontroller, and a microprocessor.

When user interaction editing information for 3D video content is input, the server processor 140 may edit a user interaction for the 3D video content according to the user interaction editing information and generate and store metadata for the edited user interaction.

In other words, the server processor 140 may provide a function of editing user interactions according to a scenario of 3D video content using a user interaction editing tool. Here, the server processor 140 may edit a type of user interaction, an operating time, interaction input and waiting times, and the like. The types of user interactions may include user motions, user interactions based on a push-and-pop function, such as a message, a sound, and a call based on a smart device, and the like. When editing of the user interaction for the 3D video content is completed, the server processor 140 may generate metadata for the edited user interaction.

Also, when playing of 3D video content is requested by the video content play device 200 through the server communication module 110, the server processor 140 may transmit 3D video content information including the 3D video content, metadata for the 3D video content, metadata for user interactions, 3D video content player information for playing the 3D video content, and the like to the video content play device 200 such that the 3D video content is played by the video content play device 200.

The server processor 140 may transmit a user interaction guide message for requesting a corresponding user interaction at a user interaction occurrence time, which is set according to a scenario of the played 3D video content, to the video content play device 200 through the server communication module 110.

When a user interaction recognition success message is received from the video content play device 200, the server processor 140 may play 3D video content corresponding to the user interaction.

As shown in FIG. 3, the server processor 140 may include an interactive 3D content authoring tool 142 and an interaction metadata module 146.

The interactive 3D content authoring tool 142 may provide an interactive 3D video content authoring tool graphical user interface (GUI) such that the user may edit a user interaction according to a scenario of the 3D video content.

The interactive 3D content authoring tool 142 may play the 3D video content or edit a user interaction using an interactive 3D video content player application programming interface (API) and an interaction API. The interactive 3D video content player API may perform a function of recognizing a video player for playing various types of 3D video content and user interaction information to operate. The interaction API may perform a function of performing user interactions such as user motions, push-and-pop messages, and the like.

Also, the interactive 3D content authoring tool 142 may include an interactive 3D player 144. The interactive 3D player 144 may parse user interaction metadata such that the user interaction may be applied to 3D video content. Here, the interactive 3D player 144 may transmit the user interaction metadata to the video content play device 200 using a predefined communication protocol such that the user interaction may be applied to 3D video content.

The interaction metadata module 146 may generate metadata for interaction information which is edited according to the scenario of the 3D video content by the interactive 3D content authoring tool 142.

Also, the interaction metadata module 146 may cause transmission of a user interaction guide message for requesting a corresponding user interaction at a user interaction occurrence time which is set according to the played 3D video content to the video content play device 200. The interactive 3D player 144 may transmit the user interaction guide message to the video content play device 200 using the predefined communication protocol such that the user interaction guide message may be transmitted to the video content play device 200.

In addition, when metadata for user interaction recognition success is received from the video content play device 200, the interaction metadata module 146 may recognize a user interaction by analyzing the metadata and transmit the recognized user interaction information to the interactive 3D content authoring tool 142 such that 3D video content corresponding to the recognized user interaction may be provided. Then, the interactive 3D player 144 of the interactive 3D content authoring tool 142 may play the 3D video content to reflect the user interaction information.

FIG. 4 is a schematic block diagram of a video content play device according to an exemplary embodiment of the present invention, and FIG. 5 is a diagram illustrating functions of a processor shown in FIG. 4.

Referring to FIG. 4, the video content play device 200 according to the exemplary embodiment of the present invention includes a communication module 210, a memory 220, the motion recognition module 230, an output module 240, and a processor 250.

The communication module 210 may provide an interface that is required for providing signals, which are transmitted and received between the video content play device 200 and the 3D video content service server 100, in the form of packet data through a communication network. In particular, the communication module 210 may transmit and receive various types of information such as 3D video content, metadata for the 3D video content, metadata for user interactions, a user interaction guide message, a user interaction recognition success message, and the like. Also, the communication module 210 may be a device including hardware and software that are required for transmitting or receiving a control signal or a data signal to or from another network device through a wired or wireless connection. In addition, the communication module 210 may be implemented in various forms such as a short-range communication module, a wireless communication module, a mobile communication module, a wired communication module, or the like.

The memory 220 is a component for storing data related to operations of the video content play device 200. In particular, the memory 220 may store an application (program or applet) and the like for playing 3D video content, recognizing a user interaction while the 3D video content is played, and playing 3D video content reflecting a user interaction, and the stored information may be selected by the processor 250 as necessary. In other words, the memory 220 stores various types of data that are generated in the process of executing an OS or application (program or applet) for operating the video content play device 200. Here, the memory 220 collectively refers to non-volatile storage devices that continuously maintain stored information without power and volatile storage devices that require power to maintain stored information.

The motion recognition module 230 may recognize a user's action (or motion). The motion recognition module 230 may include a leap motion sensor (not shown) for detecting and recognizing a leap motion of the user, a webcam (not shown) for recognizing the position of the user, a touchscreen (not shown) for recognizing a finger motion of the user, and the like. Also, the motion recognition module 230 may further include various sensors or devices for detecting the user's motion.

The motion recognition module 230 may transmit a signal corresponding to the user's motion recognized by the leap motion sensor, the webcam, and the touchscreen to the processor 250. The user may select and execute desired 3D video content through the components (e.g., the leap motion sensor, the webcam, the touchscreen, and the like) of the motion recognition module 230. In response to the signal provided by the motion recognition module 230, the processor 250 may generate a message that will be transmitted to an external device through the communication module 210, or control signals for replaying the 3D video content through the interactive 3D video content player.

The output module 240 may output information processed by the video content play device 200 under the control of the processor 250. The output module 240 may output a video signal or an audio signal and may be implemented as a display part (not shown), a sound output part (not shown), and the like. For example, the display part may be implemented as a thin film transistor (TFT)-liquid crystal display (LCD) panel, a light-emitting diode (LED) panel, an organic LED (OLED) panel, an active matrix OLED (AMOLED) panel, a flexible panel, or the like.

The processor 250 may be implemented as at least one of an ASIC, a DSP, a PLD, an FPGA, a CPU, a microcontroller, and a microprocessor.

The processor 250 may include a web browser or application for receiving a webpage online and outputting the web browser.

In response to a 3D video content play request, the processor 250 may receive 3D video content from the 3D video content service server 100 through the communication module 210 and play the 3D video content. When a user interaction is recognized by the motion recognition module 230 while the 3D video content is played, the processor 250 may determine whether the recognized user interaction is appropriate, and when the recognized user interaction is appropriate, play 3D video content corresponding to the recognized user interaction.

When the user selects specific 3D video content from a 3D video content list provided by the 3D video content service server 100, the processor 250 may transmit a 3D video content play request message to the 3D video content service server 100 through the communication module 210.

In response to the 3D video content play request message, the processor 250 may receive the corresponding 3D video content, metadata for a user interaction, metadata for the 3D video content, 3D video content player information for playing the 3D video content, and the like from the 3D video content service server 100.

The processor 250 may play the 3D video content using a 3D video content player corresponding to the 3D video content player information.

When a user interaction guide message is received from the 3D video content service server 100 while the 3D video content is played, the processor 250 may output interaction guide information for describing user interactions applied to the video content play device 200. Here, the processor 250 may output interaction guide information through the output module 240.

In other words, the video content play device 200 has various forms such as a smart pad, a smartphone, a smart television, a kiosk, digital signage, or the like. Accordingly, the motion recognition module 230 may vary depending on the type of video content play device 200. For example, since the touchscreen of a smartphone may be configured as the motion recognition module 230 and a smart television may be configured as a leap motion sensor, different user interactions may be recognized by the smartphone and the smart television. Accordingly, the processor 250 may output interaction guide information based on the type of video content play device 200 such that a user interaction to be applied according to the type of video content play device 200 may be input. The user may do a user interaction according to the interaction guide information. Then, the motion recognition module 230 may recognize the user interaction and transmit user interaction recognition information to the processor 250.

When the user interaction recognition information is received from the motion recognition module 230, the processor 250 may determine that the recognized user interaction is appropriate for user interaction metadata which is set for the corresponding point in time. Here, the processor 250 may analyze the user interaction metadata received from the 3D video content service server 100 to determine whether the recognized user interaction is appropriate for the user interaction metadata which is set for the corresponding point in time.

When the user interaction is appropriate, the processor 250 may transmit a user interaction recognition success message to the 3D video content service server 100, receive 3D video content corresponding to the user interaction from the 3D video content service server 100, and play the 3D video content.

As shown in FIG. 5, the processor 250 may include a user interaction GUI 252, an interactive 3D player 254, an interactive 3D player 254, and an interaction metadata parser 256.

The user interaction GUI 252 may transmit a user interaction recognized by the motion recognition module 230 to an interaction metadata parser 256 so that it may be determined whether the recognized user interaction is appropriate for user interaction metadata which is set for a corresponding point in time.

When the recognized user interaction is appropriate for the user interaction metadata, the user interaction GUI 252 may transmit a user interaction recognition success message to the 3D video content service server 100 through the communication module 210, receive 3D video content corresponding to the user interaction from the 3D video content service server 100, and cause the interactive 3D player 254 to play the 3D video content.

Also, the user interaction GUI 252 may perform a function of recognizing and applying a user interaction which is applied according to an environment of the video content play device 200, such as a smart pad, a smart television, a kiosk, or the like, using a device interaction API Device_Interaction_API. In other words, when a user interaction guide message is received from the 3D video content service server 100, the user interaction GUI 252 may use the device interaction API to recognize a type of video content play device 200 and output interaction guide information for describing user interactions applied to the recognized type of video content play device 200.

The interactive 3D player 254 may play the 3D video content received from the 3D video content service server 100. Also, the interactive 3D player 254 may play the 3D video content corresponding to the user interaction recognized by the user interaction GUI 252.

The interaction metadata parser 256 may perform a function of recognizing user interaction metadata for 3D video content being played. In other words, the interaction metadata parser 256 may determine whether the user interaction transmitted from the user interaction GUI 252 is appropriate for the user interaction metadata which is set for the point in time and transmit the determination result to the user interaction GUI 252.

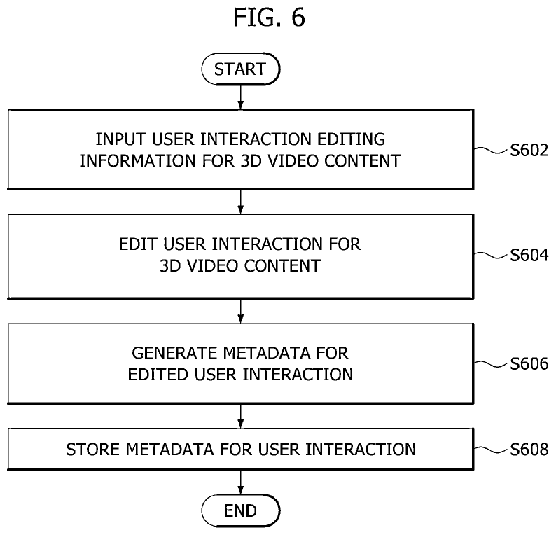

FIG. 6 is a flowchart illustrating a method of editing a user interaction for 3D video content according to an exemplary embodiment of the present invention.

Referring to FIG. 6, when user interaction editing information for 3D video content is input (S602), the server processor 140 edits a user interaction for the 3D video content according to the user interaction editing information (S604). A user may edit a user interaction according to a scenario of the 3D video content using an interactive 3D video content authoring tool GUI. Here, the user may edit a type of user interaction, an operating time, interaction input and waiting times, and the like.

When operation S604 is performed, the server processor 140 generates metadata for the edited user interaction (S606) and stores the generated metadata for the user interaction (S608).

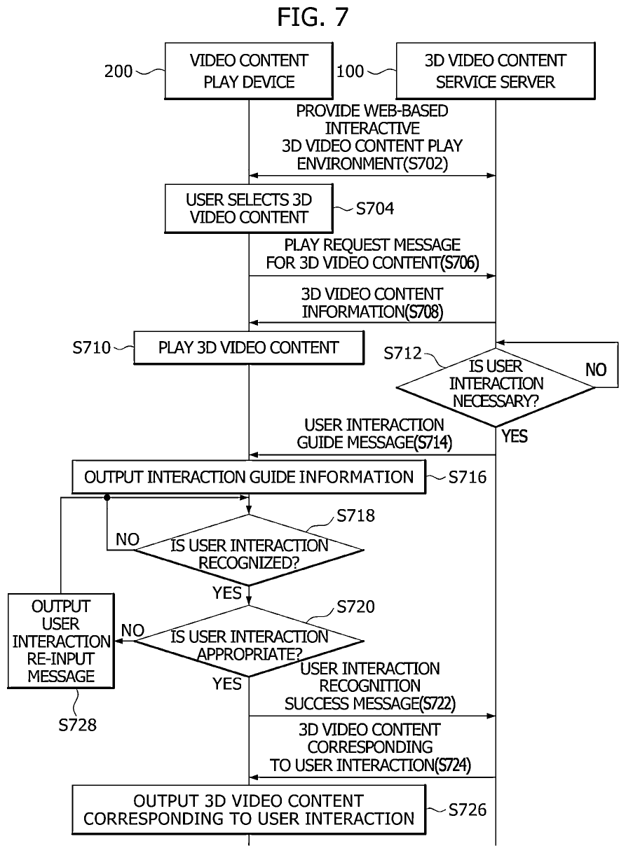

FIG. 7 is a flowchart illustrating a method of providing 3D video content according to an exemplary embodiment of the present invention.

Referring to FIG. 7, the 3D video content service server 100 provides a web-based interactive 3D video content play environment on the video content play device 200 (S702). For example, the web-based interactive 3D video content play environment may include a web-based 3D video content play application. The web-based 3D video content play application may have a user interface (UI), and the 3D video content service server 100 may provide a list of interactive 3D video content that may be provided by the 3D video content service server 100 through the UI and provide an environment for playing interactive 3D video content selected from the provided list.

When operation S702 is performed, the video content play device 200 receives a selection of 3D video content from a user (S704) and transmits a play request message for the selected 3D video content to the 3D video content service server 100 (S706).

When operation S706 is performed, the 3D video content service server 100 transmits 3D video content information including the 3D video content of which playing is requested, user interaction metadata, metadata for the 3D video content, 3D video content player information, and the like to the video content play device 200 (S708).

When operation S708 is performed, the video content play device 200 plays the 3D video content using a 3D video content player corresponding to the 3D video content player information (S710).

During operation S710, the 3D video content service server 100 determines whether a user interaction which is set according to a scenario of the played 3D video content is necessary (S712). In other words, the 3D video content service server 100 may determine whether it is a user interaction occurrence time point.

When it is determined in operation S712 that the user interaction is necessary, the 3D video content service server 100 transmits a user interaction guide message for requesting the user interaction to the video content play device 200 (S714).

When operation S714 is performed, the video content play device 200 outputs interaction guide information for describing the user interaction applied to the video content play device 200 (S716). In other words, the video content play device 200 may output interaction guide information according to the type of video content play device such that a user interaction applied according to the type of video content play device 200 may be input. The user may do the user interaction according to the interaction guide information.

After operation S716 is performed, when a user interaction is recognized (S718), the video content play device 200 determines whether the recognized user interaction is appropriate for user interaction information set for the corresponding point in time (S720). Here, the video content play device 200 may analyze metadata for the user interaction to determine whether the user interaction is appropriate for the user interaction information set for the corresponding point in time.

When it is determined in operation S720 that the recognized user interaction is appropriate, the video content play device 200 transmits a user interaction recognition success message to the 3D video content service server 100 (S722).

When operation S722 is performed, the 3D video content service server 100 provides 3D video content corresponding to the user interaction on the video content play device 200 (S724). Here, the 3D video content service server 100 may play the follow-up video content which reflects the user interaction.

When operation S724 is performed, the video content play device 200 outputs the 3D video content corresponding to the user interaction (S726).

On the other hand, when it is determined in operation S720 that the recognized user interaction is inappropriate, the video content play device 200 outputs a user interaction re-input message (S728) and performs operation S718.

According to an aspect of the present invention, user interactions are edited and generated according to various scenarios, and 3D videos are played according to the user interactions on various platforms which are provided in web service environments. Accordingly, it is unnecessary to install additional software for playing interactive 3D video content, and a user's interest and immersion can be increased when the user views 3D video content.

Although the present invention has been described above with reference to embodiments illustrated in the drawings, the embodiments are merely illustrative, and those skilled in the art should understand that various modifications and other equivalent embodiments can be made from the embodiments.

Therefore, the technical scope of the present invention should be determined from the following claims.

What is claimed is:

1. A server for providing a three-dimensional (3D) video content service, the server comprising:
a server communication module;
a server memory; and
a server processor connected to the server communication module and the server memory,
wherein, when user interaction editing information for 3D video content is input, the server processor edits a user interaction for the 3D video content according to the user interaction editing information and generates and stores metadata for the edited user interaction.

2. The server of claim 1, wherein, when a video content play device requests the server processor to play the 3D video content through the server communication module, the server processor transmits 3D video content information including at least one of the 3D video content, metadata for the 3D video content, the metadata for the user interaction, and 3D video content player information to the video content play device such that the 3D video content is played by the video content play device.

3. The server of claim 2, wherein the server processor transmits a user interaction guide message for requesting a corresponding user interaction at a user interaction occurrence time which is set according to a scenario of the played 3D video content to the video content play device through the server communication module.

4. The server of claim 3, wherein, when a user interaction recognition success message is received from the video content play device, the server processor plays 3D video content corresponding to the user interaction.

5. The server of claim 1, wherein the server processor recognizes a video player which will play a plurality of types of 3D video content and user interaction information using an interactive 3D video content player application programming interface (API) and an interaction API.

6. A device for playing video content, the device comprising:
a communication module;
a memory;
a motion recognition module; and
a processor connected to the communication module, the memory, and the motion recognition module,
wherein the processor receives three-dimensional (3D) video content from a 3D video content service server through the communication module and plays the 3D video content according to a 3D video content play request, when a user interaction is recognized by the motion recognition module while the 3D video content is played, determines whether the recognized user interaction is appropriate, and when the recognized user interaction is appropriate, plays 3D video content corresponding to the recognized user interaction.

7. The device of claim 6, wherein, in response to the 3D video content play request, the processor receives 3D video content information including at least one of the 3D video content, metadata for the user interaction, metadata for the 3D video content, and 3D video content player information for playing the 3D video content from the 3D video content service server.

8. The device of claim 7, wherein the processor plays the 3D video content using a 3D video content player corresponding to the 3D video content player information.

9. The device of claim 6, wherein, when a user interaction guide message is received from the 3D video content service server while the 3D video content is played, the processor outputs interaction guide information for describing user interactions applied to the video content play device.

10. The device of claim 6, wherein the processor determines whether the recognized user interaction is appropriate for user interaction metadata which is set for a corresponding point in time, and when the recognized user interaction is appropriate, transmits a user interaction recognition success message to the 3D video content service server, receives 3D video content corresponding to the user interaction from the 3D video content service server, and plays the received 3D video content.

11. The device of claim 6, wherein the motion recognition module includes at least one of a leap motion device, a webcam, and a touchscreen.

12. A method of providing a three-dimensional (3D) video content service according to a user interaction, the method comprising:
providing, by a 3D video content service server, a web-based interactive 3D video content play environment on a video content play device;
transmitting, by the 3D video content service server, 3D video content information of 3D video content requested by the video content play device to the video content play device;
playing, by the video content play device, the 3D video content;
when the played 3D video content requires a user interaction, transmitting, by the 3D video content service server, a user interaction guide message to the video content play device; and
when a user interaction is recognized, playing, by the video content play device, 3D video content corresponding to the recognized user interaction.

13. The method of claim 12, wherein the playing of the 3D video content comprises playing, by the video content play device, the 3D video content using a 3D video content player corresponding to 3D video content player information included in the 3D video content information.

14. The method of claim 12, wherein the playing of the 3D video content corresponding to the recognized user interaction comprises:
outputting, by the video content play device, interaction guide information for describing user interactions applied to the video content play device;
when the user interaction is recognized, determining, by the video content play device, whether the recognized user interaction is appropriate; and
when the user interaction is appropriate, playing, by the video content play device, 3D video content corresponding to the recognized user interaction.

15. The method of claim 14, wherein the outputting of the interaction guide information comprises recognizing, by the video content play device, a type of video content play device using a device interaction application programming interface (API) and outputting interaction guide information for describing user interactions applied to the recognized type of video content play device.

16. The method of claim 14, wherein the determining of whether the recognized user interaction is appropriate comprises determining, by the video content play device, whether the recognized user interaction is appropriate for user interaction metadata which is set for a corresponding point in time.

17. The method of claim 14, wherein the playing, by the video content play device, of the 3D video content corresponding to the recognized user interaction when the user interaction is appropriate comprises:
transmitting, by the video content play device, a user interaction recognition success message to the 3D video content service server;
analyzing, by the 3D video content service server, user interaction metadata included in the user interaction recognition success message to recognize the user interaction and providing 3D video content corresponding to the recognized user interaction to the video content play device; and
receiving and playing, by the video content play device, the 3D video content corresponding to the user interaction.

18. The method of claim 12, further comprising:
receiving, by the 3D video content service server, user interaction editing information for the 3D video content to edit the user interaction for the 3D video content; and
generating, by the 3D video content service server, metadata for the edited user interaction.
